(19) United States
(12) Patent Application Publication
(10) Pub. No.: US 2026/0218554 A1
(43) Pub. Date: Jul. 30, 2026

(54) Closure Device

(71) Applicant: SAMET KALIP VE MADENI ESYA SANAYI VE TICARET A.S., Istanbul (TR)

(72) Inventors: Artur Hirtsiefer, Neunkirchen-Seelscheid (DE); Himmet Tanriverdi, Istanbul (TR); Evren Urak, Istanbul (TR)

(21) Appl. No.: 19/157,911

(22) PCT Filed: Mar. 9, 2023
(86) PCT No.: PCT/TR2023/050237

§ 371 Date: Aug. 19, 2025

(51) Int. Cl. E05D 15/34

(52) U.S. Cl. CPC E05D 15/34; E05Y 2201/21; E05Y 2201/624; E05Y 2201/688; E05Y 2900/20

(57) ABSTRACT

A closure device for attaching a movable furniture part to a stationary structure, comprising a cabinet mount for mounting to the stationary structure, and a door mount for mounting to the movable furniture part, further comprising at least one arm pivotably connected to the cabinet mount about a pivot axis of a cabinet mount pivot bearing and further pivotably connected to the door mount about a pivot axis of a door mount pivot bearing. Enhanced load-bearing capacity is achieved in that the at least one arm comprises guiding means for load transmission in a load transmission direction (LD) direction parallel to a pivot axis of the cabinet mount pivot bearing and/or of the door mount pivot bearing.

The invention relates to a closure device for movable attachment of at least one movable furniture part, such as a door or a flap, to a stationary structure, such as a cabinet, wherein the closure device is configured to enable movement of the movable furniture part from a closed to an open state, comprising at least one cabinet mount for mounting to the stationary structure, and at least one door mount for mounting to the movable furniture part, further comprising at least one arm pivotably connected to the cabinet mount about a pivot axis of a cabinet mount pivot bearing, wherein the at least one arm is further pivotably connected to the door mount about a pivot axis of a door mount pivot bearing, wherein the at least one arm is pivotable between a closed and an open position configured to correspond to the closed and the open state of the movable furniture part, respectively.

A closure device is known from U.S. Pat. No. 10,407,961 B2 . The closure device comprises a cabinet attachment member attached to a cabinet frame and a door attachment member attached to a door. Further, two arms are provided that are coupled to the cabinet attachment member in a manner pivotable about respective first pivot axes and that are coupled to the door attachment member in a manner pivotable about respective second pivot axes. The coupling of the arms to the cabinet attachment member is achieved by bearing pins (pin shaped fasteners) that are guided through openings in the cabinet attachment member and the arms.

A problem with known closure devices of the type mentioned in the beginning is that the transmission of a load on the arm, for example due to the weight of an attached door, must be supported to a large extent by the bearing arrangement at the first pivot axis. Such a load may typically be oriented substantially parallel to the first pivot axis. In a closure device of the known type, this load will thus lead to a substantial bending torque on bearing pins which may lead to increased wear and/or may inhibit rotatability at the pivot bearing.

The technical problem solved by the invention is to provide a closure device with enhanced load-bearing capacity that provides comfortable and smooth operation.

The problem is solved in that the at least one arm comprises guiding means for transmitting a load at least partially in a load transmission direction parallel to the pivot axis of the cabinet mount pivot bearing and/or the pivot axis of the door mount pivot bearing.

In this way, additional load-bearing capacity is provided. In particular, the guiding means may provide for an additional bearing and guidance that may be dedicated to support a substantial amount of the load to another element of the closure device and/or the cabinet. For instance, the load may be at least partially transmitted to the stationary structure and/or the cabinet mount of the closure device.

This means that the cabinet mount pivot bearing may be relieved from a large amount of a heavy load, for instance due to a heavy door, and may thus be able to perform better at its actual purpose, namely providing pivotability to the at least one arm. In this context, the pivot bearing may also be designed more efficiently, for example, it could be dimensioned smaller.

In an arrangement of a cabinet with doors that are movable between an open and a closed state in a substantially horizontal direction, the load transmission direction may at least partially coincide with the direction of the weight of a door.

Improved leverage conditions for the bearing of the load may be achieved in that, in a direction transverse to the pivot axis of the cabinet mount pivot bearing, the guiding means are spaced apart from said pivot axis. In this context, the direction transverse to the pivot axis may in particular be perpendicular to the pivot axis. Preferably, the spacing may be along a longitudinal direction of the at least one arm and further preferably toward the respective door mount pivot bearing. It may further be preferable to provide the guiding means separate and spaced apart from the cabinet mount pivot bearing.

Spacing of the guiding means from the pivot axis and/or the cabinet mount pivot bearing may be such that a lever arm resulting in between the guiding means 16 and the pivot axis and/or the cabinet mount pivot bearing is sufficiently long to reduce bending forces on the cabinet mount pivot bearing. The length of the spacing may be designed according to an expected load that needs to be transmitted. For instance, the spacing may be at least 10 % of a distance between the pivot axis of the cabinet mount pivot bearing and the pivot axis of the door mount pivot bearing. For larger loads, e.g. due to heavier doors, a larger spacing of at least 15 %, preferably at least 20 %, most preferably at least 25 % may be provided. The spacing may be measured from the pivot axis of the cabinet mount pivot bearing to the closest point where the guiding means is in load-transmitting contact (transmitting in the transmission direction) with another component, e.g. the cabinet mount and/or the cabinet.

Said spacing may lead to a corresponding force in the opposite direction of the load transmission direction to balance a torque introduced on the arm by said lever arm. Such a corresponding force may be supported in the area of the cabinet mount pivot bearing and/or in the area of a pivot axis thereof. However, it need not be supported by a bearing pin, which could lead to increased wear and/or inhibited rotatability. In particular, the corresponding force may not result in a bending torque on the cabinet mount pivot bearing.

Hence, it is proposed that the arm comprises a contact surface that may be in contact with an element of the cabinet mount and/or the cabinet and that may transmit this corresponding force to balance the torque introduced into the arm due to said spacing of the guiding means. The contact surface may be adapted to provide for reduced friction, for example, it may be designed as a washer, which may be made from a low friction material. The contact surface may be in load-transmitting contact with a mounting plate and/or a cover plate of the cabinet mount.

Alternatively or additionally, for balancing the corresponding force, it may be envisaged that a further guiding means is provided in addition to the guiding means, but provided on the arm on an opposite side relative to the cabinet mount pivot bearing. In other words, the arm may be extending to two opposite sides of the cabinet mount pivot bearing, where each of the opposite sides may comprise guiding means.

Smooth guidance and reduced friction may be achieved in that the guiding means comprise a roller that is rotatable about an axis transverse to the to the pivot axis of the cabinet mount pivot bearing. Preferably, the roller may be rotatable about an axis that is perpendicular to the pivot axis of the cabinet mount pivot bearing. Particularly preferably, the axis may further be perpendicular to the load transmission direction.

A mechanically stable and compact design may be achieved in that the roller is at partially received in a roller receptacle of the arm, and in that an outer circumferential surface of the roller partially protrudes from the roller receptacle in and/or against the load transmission direction.

A simple design of the guiding means may be provided if the roller is mounted to the arm by means of an axle, and if the axle is at least partially received in an axle receptacle of the arm. This may also provide for a robust support of the axle. The guiding means may be particularly easy to assemble if it is provided that the roller receptacle and the axle receptacle are in spatial connection with one another. In this way, the axle and the roller may be pre-assembled and inserted into their respective receptacles as a pre-assembled unit.

Smooth opening and closing of a movable furniture part connected to the closure device may be achieved if it is provided that, during pivoting of the at least one arm between the closed and an open position, the roller rolls on an element of the cabinet mount arranged adjacent to the roller in the load transmission direction. Preferably, the element of the cabinet mount provides a smooth and stable rolling surface for the roller. In this context, it may be advantageous if the roller rolls on a mounting plate of the cabinet mount.

A compact and mechanically stable design may be achieved in that the at least one arm comprises a bearing segment, and in that the bearing segment at least partially comprises the cabinet mount pivot bearing, and in that the first bearing segment comprises the guiding means. For instance, the bearing segment may comprise a bearing bore of the cabinet mount pivot bearing through which a bearing pin may be guided. Together with suitable attachment means of the cabinet mount, these components may form the cabinet mount pivot bearing.

It may be preferable that the length of the at least one arm is adjustable. Therefore, it is suggested to provide that the at least one arm comprises at least two segments, wherein the at least two segments can be secured to one another in different relative positions to one another in a longitudinal direction of the arm.

Comfort in operation of the closure device may further be enhanced if at least one opening and/or closing device is provided, in that the opening and/or closing device biases the at least one arm toward the closed position during a first part of the pivoting between the closed and the open position, and/or in that the opening and/or closing device biases the at least one arm toward the open position during a second part of the pivoting between the closed and an open position. In this way, a user may effortlessly move the closure device into the closed and/or the open position, and/or move a door between the closed and the open state. This may provide a significant improvement especially if heavy doors are connected to a cabinet by means of the closure device.

Reliable support of the opening and closing may be achieved in that the opening and/or closing device comprises a spring. A simple yet effective design of the opening/closing means may in this context be characterized in that the spring extends between a first attachment section with which the spring is coupled directly or indirectly to a second connecting element that is connected to the at least one arm and a second attachment section with which the spring, is directly or indirectly coupled to a spring mount, wherein the spring mount is preferably stationary relative to the cabinet mount, in particular secured to the cabinet mount and/or adapted to be secured to the stationary structure.

An opening/closing means that may provide support on both the opening and the closing direction may be achieved by simple means, if it is provided that the spring mount, the second connecting element and the cabinet mount pivot bearing are arranged such that, between the first part and the second part of pivoting of the arm between the closed and the open position, a reversal point of the spring force is crossed. If it is, in this context, envisaged that the spring is a tension spring, it may be preferably provided that, during the first part of the pivoting, the spring is lengthened, and that further preferably, during the second part of the pivoting, the spring is shortened.

Comfort in operation of the closure device may also be enhanced if at least one damping device is provided, that damps pivoting of the at least one arm toward along at least a fraction of the pivoting movement when approaching the closed and/or the open position. This may be especially advantageous if heavy loads, for instance heavy doors are moved between an open and a closed state. Heavy doors may carry a significant amount of momentum that, without damping means, could otherwise lead to increased wear on components of the cabinet and/or the closure device. Further, without a damping device, the doors might tend to slam shut or open. This may in particular be the case if an opening/closing device is provided.

Preferably the damping device may comprise a stop surface, wherein further preferably the least one arm comprises a counter-stop surface, and wherein further preferably the counter-stop surface engages with the stop surface when approaching the closed and/or the open position. This may provide for a simple and efficient design.

Reduced friction between the/a counter-stop surface of the at least one arm and the/a stop surface of the damping device may be achieved if the counter-stop surface is comprised by an outer circumferential surface of a disk, wherein the disk is rotatably held on the arm. This way, the counter-stop surface may roll on the stop surface to some extent.

Preferably, the disk may be rotatable about an axis parallel to the pivot axis of the cabinet mount pivot bearing.

A mechanically robust and compact design may be achieved if it is provided that the disk is partially received in a disk receptacle of the arm, such that the counter-stop surface partially protrudes from the disk receptacle.

In order to provide for the movement of heavier movable furniture parts, and/or to provide additional degrees of freedom in the kinematics of the opening and/or closing movement, it may be desirable that more than one arm is provided. In this context, it is proposed that a first arm and a second arm are provided, that the first arm and the second arm are pivotably connected to the cabinet mount about a first pivot axis of a first cabinet mount pivot bearing and a second pivot axis of a second cabinet mount pivot bearing, respectively, that the first arm and the second arm are further pivotably connected to the door mount about a third pivot axis of a first door mount pivot bearing and a fourth pivot axis of a second door mount pivot bearing, respectively, wherein the arms are pivotable between a closed and an open position configured to correspond to the closed and the open state of the movable furniture part, respectively.

A preferred embodiment of the invention may be characterized in that, in the closed position, viewed from the first and second pivot axes in a direction toward the third and fourth pivot axes, a first straight line intersecting the first and third pivot axes and a second straight line intersecting the second and fourth pivot axes converge at an acute first angle. When the arms are moved from the closed position, the pivot axes follow arcuate first and second paths, respectively, centered around the respective pivot axes. Due to the above-described first angle, in vicinity of the closed position, the second path may have a larger directional component facing away from the cabinet compared to the first path. This leads to a certain degree of tilting of the door, which allows the door to reliably bypass, without collision, an adjacent door or furniture part that may be provided. Importantly, this advantage is achieved without having to arrange the arms, or the respective straight lines, at a very small angle to the door, as may be necessary if the first angle were not provided as proposed. Therefore, an angular arrangement that is significantly better suited to counteract tilting forces on the door may be provided in comparison to the state of the art. Hence, small gaps and enhanced stability can be achieved at the same time.

In accordance with an independent inventive idea, convenience of operation of a closure device according to the preamble of claim 1 can be improved in that at least one opening and/or closing device is provided, in that the opening and/or closing device biases the at least one arm toward the closed position during a first part of the pivoting between the closed and the open position, and/or in that the opening and/or closing device biases the at least one arm toward the open position during a second part of the pivoting between the closed and an open position.

Such a closure device may also be characterized by additional features for which reference is made to the preceding paragraphs.

In the following, the invention will be described in more detail with reference to the figures. The figures show:

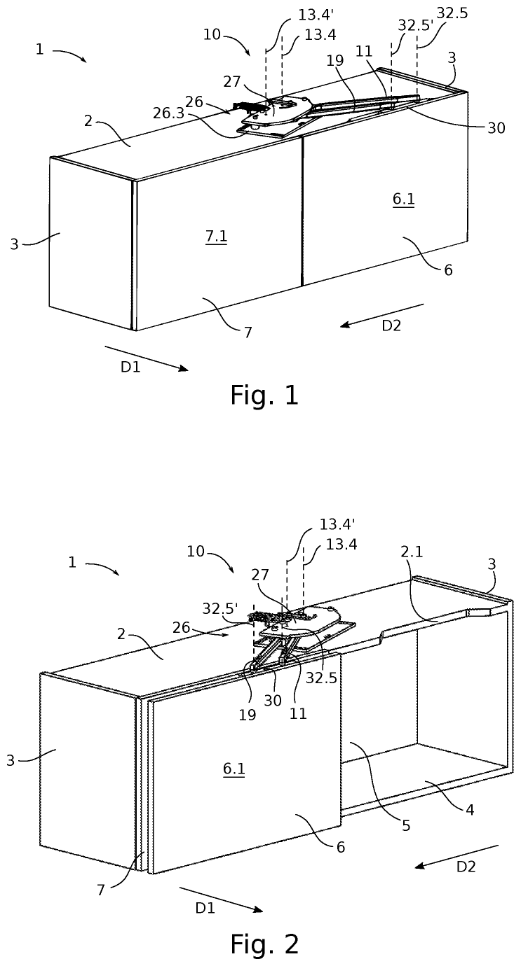

FIG. 1: a schematic perspective view of a cabinet 1 with a closure device 10 in a closed position,

FIG. 2: a schematic perspective view of a cabinet 1 with a closure device 10 in an open position,

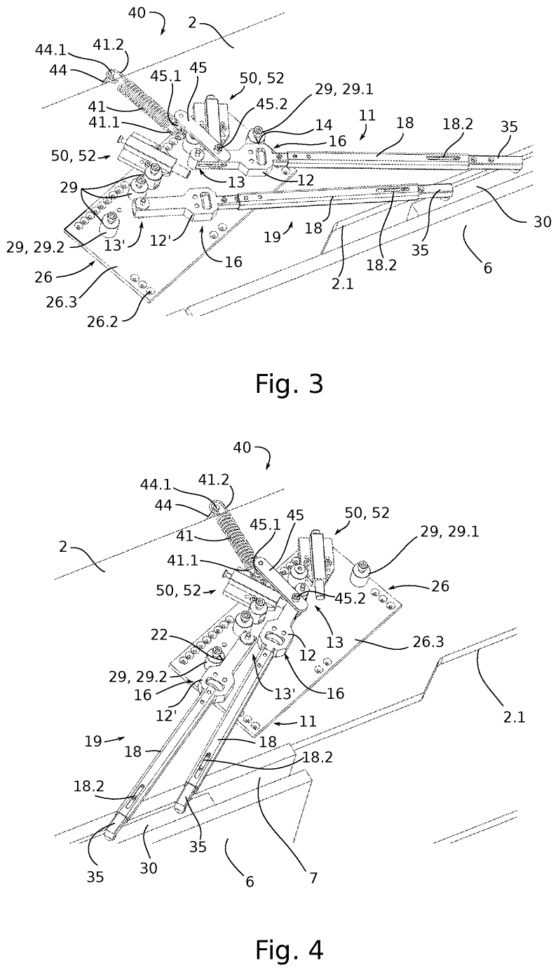

FIG. 3: a schematic perspective view of a closure device 10 in a closed position,

FIG. 4: a schematic perspective view of a closure device 10 in an open position,

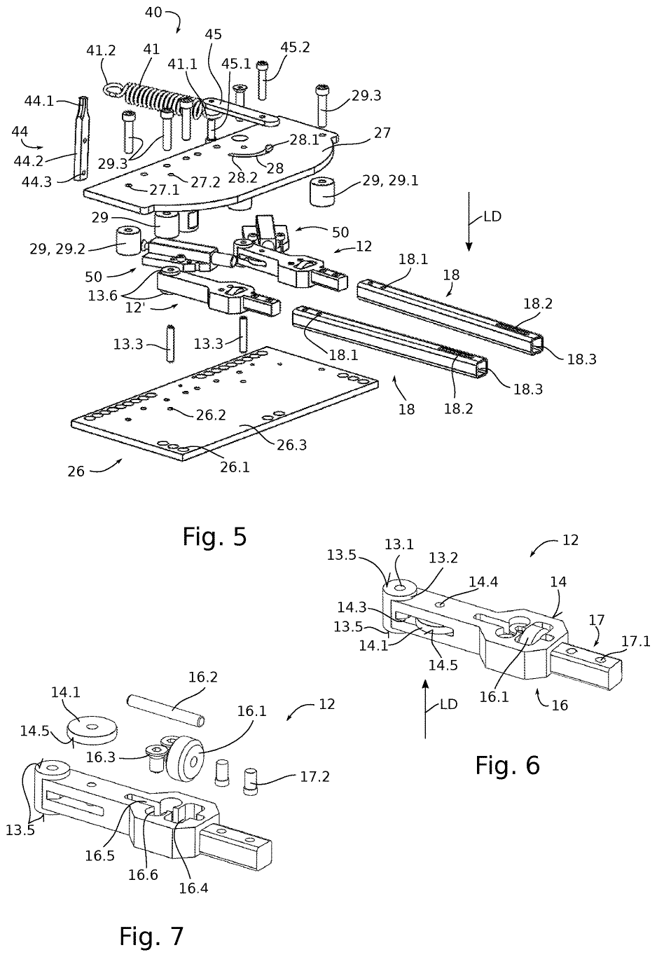

FIG. 5: a schematic exploded view of a closure device 10,

FIG. 6: a schematic perspective view of a first bearing segment 12,

FIG. 7: a schematic exploded view of a first bearing segment 12,

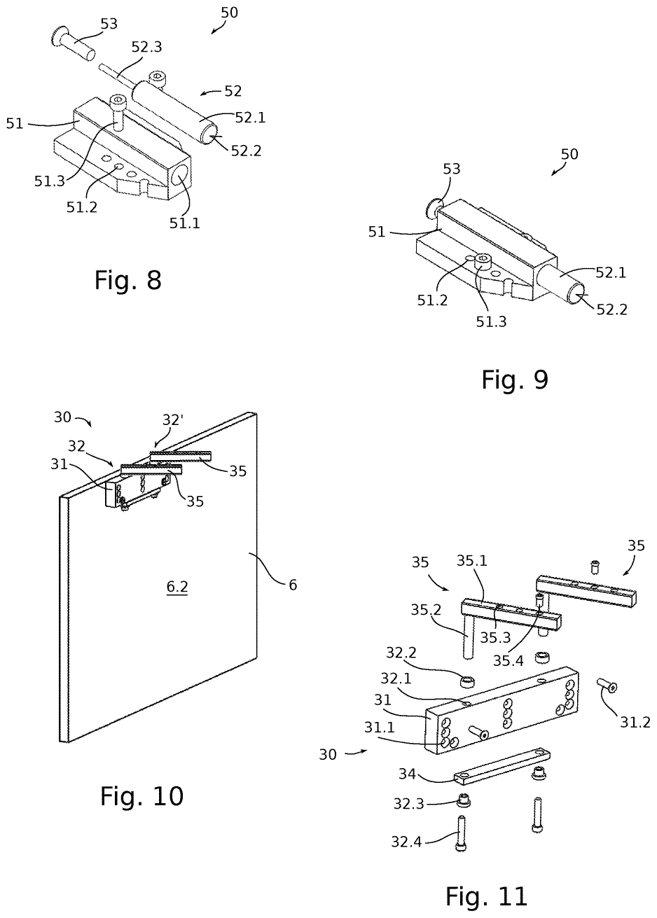

FIG. 8: a schematic exploded view of a damping device 50,

FIG. 9: a schematic perspective view of a damping device 50,

FIG. 10: a schematic perspective view of a door mount 30 mounted to a door 6,

FIG. 11: a schematic exploded view of a door mount 30,

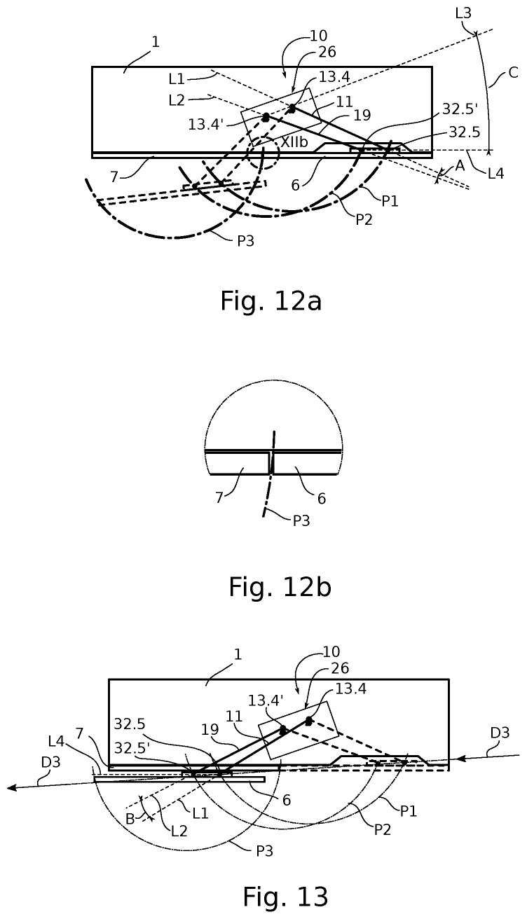

FIG. 12a: a schematic top view of a cabinet 1 with a closure device 10 in a closed position,

FIG. 12b: a view of a detail marked with XIIb in FIG. 12a,

FIG. 13: a schematic top view of a cabinet 1 with a closure device 10 in an open position,

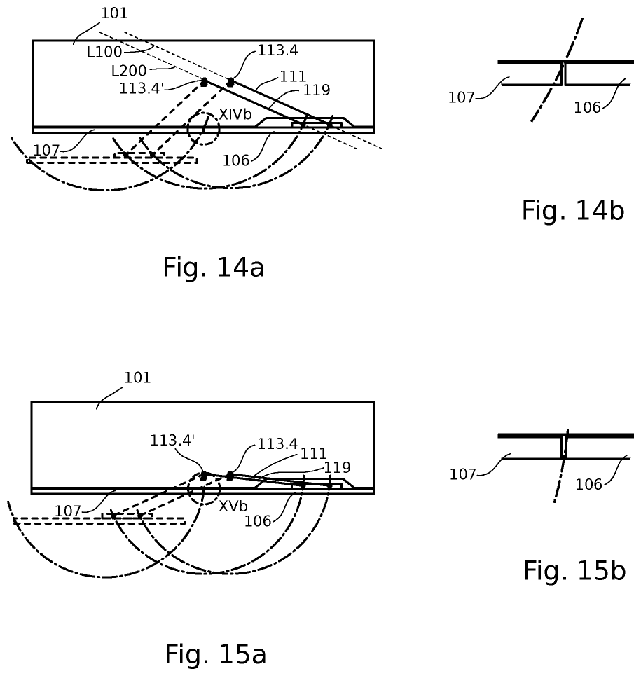

FIG. 14 a: a schematic top view of a cabinet 101 with a closure device in a closed position,

FIG. 14b: a view of a detail marked with XIVb in FIG. 14a,

FIG. 15 a: a schematic top view of a cabinet 101 with another closure device in a closed position,

FIG. 15b: a view of a detail marked with XVb in FIG. 15a.

In the figures, there is shown an embodiment where a closure device 10 is mounted on a stationary structure embodied by a cabinet 1. However, the stationary structure need not be restricted to be a cabinet. Rather, a stationary structure could be any kind of furniture or non-furniture item. Stationary need not be understood in a strict sense, but may rather mean stationary relative to the opening movement of the movable furniture part. In this sense, a cabinet 1 that may be configured to be movable, for instance a cabinet 1 that comprises wheels so that it may easily be moved around, may be considered a stationary structure.

Further, the closure device 10 in the embodiment of the figures serves to move a door 6 in a substantially horizontal way between a closed and an open state. In such an embodiment, the/a closure device 10 may be mounted in the region of a top wall 2 and/or a bottom wall 4 of a stationary structure. However, it is also conceivable that the closure device 10 is used to move a movable furniture part between a closed and an open state in a different direction. For instance, the closure device 10 may be used and/or may be designed for moving a flap between a closed and an open state in a vertical direction. In such an embodiment, the/a closure device 10 may be mounted in the region of a one or more side walls 3 of a stationary structure.

FIGS. 1 and 2 show a cabinet 1 with a door 6 and a second door 7. In FIG. 1, the doors 6, 7 are in a closed state. In the closed state, the door 6 and the second door 7 may be within one plane, i.e. there may be no offset between front faces 6.1, 7.1 of the doors 6, 7 in a first direction D1 normal to one of and/or both front faces 6.1, 7.1, preferably a front face in the closed state, and the facing away from the cabinet 1.

In FIG. 2, the door 6 is in the open state. In the open state, the door 6 may be located at least partially in front of the second door 7 with respect to the first direction D1. Compared to the closed state, in the open state the door 6 may be displaced at least partially in a second direction D2. The second direction D2 may be perpendicular to first direction D1 and parallel to one of and/or both front faces 6.1, 7.1, preferably a front face in the closed state, and/or substantially horizontal.

In order to ensure movability of the door 6 between the open and the closed state, the cabinet 1 may be provided with a closure device 10. As shown in the Figures, the closure device 10 may be mounted on a top wall 2 of the cabinet 1. Alternatively, the closure device 10 may be mounted to the bottom of the top wall 2.

Preferably, a cabinet mount 26 is provided for mounting the closure device 10 to the cabinet 1.

It is conceivable that a further closure device 10 may be mounted to another part of the cabinet 1. For instance, a further closure device 10 may be mounted on top of or below a bottom wall 4 of the cabinet.

The closure device 10 may comprise a first arm 11 and a second arm 19 that may each be pivotable about pivot axes 13.4, 13.4′ of a first cabinet mount pivot bearing 13 and a second cabinet mount pivot bearing 13′, respectively. The arms 11, 19 may be coupled to a door mount 30 which may be secured to the door 6. In particular, the door mount 30 may be secured to a rear face 6.2 of the door 6 (cf. FIG. 10).

As shown in the Figures, the arms 11, 19 may be coupled to the door mount 30 in a manner pivotable about pivot axes 32.5, 32.5′, respectively. The cabinet 1 may, in its top wall 2, comprise a recess 2.1 that may at least partially receive the door mount 30 when the door 6 is in the closed state.

FIGS. 3 and 4 show the closure device 10 in more detail. For better visibility of the other components, a cover plate 27 (cf. FIG. 5) of a cabinet mount 26 of the closure device 10 is not shown in FIGS. 3 and 4. The cabinet mount 26 of the closure device 10 may comprise a mounting plate 26.3, that may be adapted for mounting to a part of the cabinet 1, in particular to the top wall 2. As shown in the embodiment of the Figures, the mounting plate 26.3 may comprise a number of attachment bores 26.2. Suitable fixing means, such as bolts or screws, may be passed through the attachment bores 26.2 and may engage with the cabinet 1. Of course, other means of securing the mounting plate 26.3 to the cabinet 1 are conceivable, such as gluing and/or clamping the mounting plate 26.3 down on the cabinet 1 by suitable clamping means.

The cover plate 27 of the cabinet mount 26 may be secured to the mounting plate 26.3 at a distance such that mounting plate 26.3 and cover plate 27 are substantially parallel to one another and provide a mounting space in between them. Preferably, a number of spacers 29 may be provided to keep the mounting plate 26.3 and the cover plate 27 at a distance to one another. The cover plate 27 may be secured to the mounting plate 26.3 by means of suitable fixing means 29.3, for example, by bolts of screws.

As in the embodiment shown in the Figures, the spacers 29 may comprise bores 29.4 through which the fixing means 29.3 may be guided. The cover plate 27 may comprise mounting bores 27.1 through which the fixing means 29.3 may be guided. The fixing means 29.3 may be screwed into corresponding mounting bores 26.1 of the mounting plate 26.3 which may be provided with a thread.

The arms 11, 19 may be pivotably connected to the mounting plate 26.3 and/or the cover plate 27 in the region of the cabinet mount pivot bearings 13, 13′. The cabinet mount pivot bearings 13, 13′ may enable pivoting of the arms 11, 19 about respective pivot axes 13.4, 13.4′. The arms 11, 19 may each comprise a bearing segments 12, 12′, comprising elements of the cabinet mount pivot bearings 13, 13′. Further, the arms 11, 19 may each comprise a connecting segment 18, 18′ that may be detachably connected to a respective bearing segment 12, 12′.

The arms 11, 19 may, at an end opposite to the cabinet mount pivot bearings 13, 13′, be coupled to the door mount 30. The arms 11, 19 may be pivotable relative to the door mount 30 about pivot axes 32.5, 32.5′. In particular, the arms 11, 19 may be comprise two holding segments 35, that may be detachably connected to a respective connecting segment 18, 18′, wherein the holding segments 35 may be pivotable about said pivot axes 32.5, 32.5′.

FIGS. 6 and 7 show a more detailed view of the first bearing segment 12. The second bearing segment 12′ may be designed in the same way as the first bearing segment 12. It may, however, as in the embodiment shown, there may be some deviations between the first and the second bearing element 12, 12′. For now, the first bearing segment 12 will be described in more detail as a representative for both bearing segments 12, 12′, such that the description is analogously transferable to the second bearing segment 12.

In the region of the cabinet mount pivot bearing 13, the first bearing segment 12 may comprise a bearing bore 13.1, in which a bearing pin 13.3 may be at least partially received. The bearing pin 13.3 may be further received in an attachment bore 26.2 of the mounting plate 26.3 and/or an attachment bore 27.2 of the cover plate 27. To provide pivotability of the first arm 11 about the first cabinet mount pivot bearing 13, the bearing pin 13.3 may be held rotatably in the bearing bore 13.1 and/or one or both of the attachment bores 26.2, 27.2.

In the region of the first cabinet mount pivot bearing 13 (cf. FIG. 3), the first bearing segment 12 may have a spacing protrusion 13.2. The spacing protrusion 13.2 may have an extension along the pivot axis 13.4 that is less than the distance between the mounting plate 26.3 and the cover plate 27. However, this extension may be only slightly less than the distance between the mounting plate 26.3 and the cover plate 27, for example less than 1 mm or less than 0.5 mm.

Opposite the region of the first cabinet mount pivot bearing 13, the first bearing segment 12 may comprise a mounting attachment 17. The mounting attachment 17 may have a polygonal cross section. Mounting bores 17.1, which may comprise an internal thread, may be provided on the mounting attachment 17. The mounting attachment 17 may be receivable in a receiving space 18.3 of the connecting segment 18. Preferably, the connecting segment 18 may be a hollow profile encompassing the receiving space 18.3.

In the region to receive the mounting attachment 17 of the first bearing segment 12, the connecting segment 18 may comprise mounting bores 18.1 (cf. FIG. 5). Through the mounting bores 18.1 of the connecting segment 18 and the mounting bores 17.1 of the mounting attachment 17, suitable fixing means, such as mounting bolts 17.2 (cf. FIG. 7) may be guided. For example, the mounting attachment 17 and the connecting segment 18 may be secured to one another by screws or bolts guided through the mounting bores 17.1, 18.1.

Turning back to the first bearing segment 12, as seen in FIGS. 6 and 7, there may be a guiding means 16 provided in between the region of the first cabinet mount pivot bearing 13 and the mounting attachment 17. The guiding means 16 may be spaced apart and separate from the first cabinet mount pivot bearing 13 along a longitudinal direction of the first bearing segment 12. The guiding means 16 may serve to guide the first bearing segment 12 on the mounting plate 26.3. At least partially by means of the guiding means 16, a load, for example at least part of the weight of the door 6, may be transferred to the cabinet 1. The load may be transmitted in a load transmission direction (LD), which may be essentially parallel to the pivot axis 13.4, 13.4′. In particular, in the case of a cabinet 1 with a horizontally movable door 6, the load transmission direction LD may be aligned with the force vector of the weight of the door 6 and thus be essentially vertical. In FIGS. 6 and 7, the first bearing segment 12 is shown rotated upside down for visibility purposes, such that the load transmission direction LD is pointing upwards in these Figures.

Spacing of the guiding means 16 from the pivot axis and/or the cabinet mount pivot bearing may be such that a lever arm resulting in between the guiding means 16 and the pivot axis 13.4 and/or the cabinet mount pivot bearing 13 is sufficiently long to reduce bending forces on the cabinet mount pivot bearing 13. Said lever arm may introduce a torque into the first bearing segment 12 that may need to be balanced by corresponding force in the opposite direction of the load transmission direction LD. As seen in the Figures, for this purpose, the first bearing segment 12 may comprise a contact surface 13.5 that may be in load-transmitting contact with the mounting plate 26.3 and/or the cover plate 27 of the cabinet mount 26. The contact surface 13.5 may be adapted to provide for reduced friction. The contact surface 13.5 may be arranged in the area of the cabinet mount pivot bearing 13, in particular arranged at the pivot axis 13.4.

As seen in FIG. 5, it may be designed as a washer 13.6, which may be made from a low friction material.

Referring back to the guiding means 16, preferably, the guiding means 16 may comprise a roller 16.1 that may roll on the mounting plate 26.3 during movement of the arms 11, 19 between the open and closed state of the closure device 10. In this context, it is preferred that the roller 16.1 is rotatable about an axis that is parallel to the longitudinal extension of the arm 11. The roller 16.1 may be received in a roller receptacle 16.4, that may be designed as an opening in the first bearing segment 12. Preferably, this opening is open at least in the direction toward the mounting plate 26.3, in particular is open at least in the load transmission direction LD. As in the embodiment shown, however, it may be open towards both the mounting plate 26.3 and the cover plate 27.

The roller 16.1 may be mounted to the first bearing segment 12 by means of an axle 16.2. The axle 16.2 may be rotatably held at the first bearing segment 12 and/or the roller 16.1 may be rotatably held on the axle 16.2. Preferably, the axle 16.2 is received in an axle receptacle 16.5 of the first bearing segment 12. The axle receptacle 16.5 may be open in the load transmission direction LD, but may preferably be closed in the opposite direction.

It is conceivable that the axle 16.2 and the roller 16.1 may be inserted together into the axle receptacle 16.5 and the roller receptacle 16.4, respectively. Afterwards, the axle 16.2 may be clamped down by clamping bolts 16.3. For the clamping bolts 16.3, bolt receptacles 16.6 may be provided adjacent to the axle receptacle 16.5, which bolt receptacles 16.6 may be threaded.

FIGS. 6 and 7 further show that a disk 14.1 may be provided in a disk receptacle 14.3 of the first bearing segment 12. The disk 14.1 may be rotatably held at least partially within the disk receptacle 14.3 by means of a second connecting element 45.2 guided through a connecting bore 14.4 of the first bearing segment 12. The disk 14.1 may be rotatable about the second connecting element 45.2 and/or the second connecting element 45.2 may be rotatably held in the connecting bore 14.4. Preferably, the disk 14.1 is rotatable about an axis that is parallel to the pivot axes 13.4, 13.4′ and/or perpendicular to the rotational axis of the roller 16.1. It is further preferable that the disk 14.1 protrudes over a surface of the first bearing segment 12 with its outer circumference. The disk 14.1 may, on its outer circumferential surface, provide a counter-stop surface 14.5 to engage with a stop surface 52.2 of a damping device 50 described further below.

It is conceivable, but not mandatory, that the second bearing segment 12′ associated with the second arm 19 does not comprise a disk 14.1 and/or a disk receptacle 14.3 (cf. FIG. 5). Otherwise, as stated above, the aspects discussed for the first bearing segment 12 are analogously applicable to the second bearing segment 12′.

As best seen in FIG. 5, the receiving space 18.3 of the connecting segments 18 may be provided on both the ends facing the bearing segments 12, 12′ as well as the ends facing the holding segments 35. In the region of the ends facing the holding segments 35, the connecting segments 18 may comprise an adjustment means 18.2. The adjustment means 18.2 may enable an adjustment of the overall length of the arms 11, 19 by adjusting the lengthwise position of the connecting segments 18 and the holding segments 35 to one another. The adjustment means 18.2 may be designed as elongated slots oriented in the lengthwise direction of the connecting segments 18.

Referring to FIG. 11, the holding segments 35 may comprise an arm portion 35.1 that may be partially receivable in the receiving space 18.3 of the connecting segments 18. Within the arm portion 35.1, mounting bores 35.3 may be provided that may comprise a thread. When the arm portion 35.1 is received in the receiving space 18.3, the lengthwise position of the holding segments 35 relative to the connecting segment 18 may be secured by fixing means 35.4, for example screws or bolts, guided through the adjustment means 18.2 into the mounting bores 35.3.

The holding segments 35 may further comprise a bearing attachment 35.2 that may be oriented at an angle, preferably at a right angle, to the arm portion 35.1. Preferably, the bearing attachment 35.2 may be cylindrical. The bearing attachment 35.2 may be connected to the arm portion 35.1 in an end region opposite the that to be connected to the connecting segment 18.

By means of the bearing attachment 35.2, the holding segments 35 may be rotatably attached to a mounting body 31 of the door mount 30. In particular, the mounting body 31 may comprise bearing receptacles 32.1, in which the bearing attachments 35.2 of the holding segments 35 may be at least partially received. The bearing receptacles 32.1 and/or the bearing attachments 35.2 may be oriented along the respective pivot axes 32.5, 32.5′. The bearing attachments 35.2 together with the bearing receptacles 32.1 may provide first and second door mount pivot bearings 32, 32′ (cf. FIG. 10) for the first and the second arm 11, 19, respectively. To provide a spacing between the mounting body 31 and the arm portion 35.1 and/or to support rotatability, a washer 32.2 may be placed between the mounting body 31 and the arm portion 35.1.

The bearing receptacles 32.1 may be designed as through holes through the mounting body 31. In this way, the holding segments 35 can be secured to the mounting body 31 by bolts 32.4 inserted into the bearing receptacle 32.1 from the side opposing the side from which the bearing attachments 35.2 are inserted. The bearing attachments 35.2 may comprise threaded bores partially receive the bolts 32.4. For added mechanical stability, a bottom plate 34 may be provided between the heads of the bolts 32.4 and the mounting body 31. Further, for rotatability and/or adjustment and/or spacing purposes, washers 32.3 may be provided in between the heads of the bolts 32.4 and the bottom plate 34.

The mounting body 31 may comprise mounting bores 31.1, through which suitable fixing means 31.2, for example screws or bolts may be guided to engage with the door 6, in order to secure the mounting body 31 to the door 6.

As can be seen in FIGS. 3 and 4, at least one damping device 50 may be provided. The damping device 50 may be fixed to the mounting plate 26.3. For example, the damping device 50 may be fixed to the mounting plate 26.3 by fixing means 51.3, for example bolts, guided through mounting bores 51.2 of a damping housing 51 and engaged with attachment bores 26.2 of the mounting plate 26.3.

An embodiment of a damping device 50 is shown in more detail in FIGS. 8 and 9. The damping device 50 may comprise a damper 52, which may be a fluid type damper. The damper 52 may comprise a cylinder 52.1, in which a piston is received. The piston may be coupled to a piston rod 52.3. It will be appreciated that the damper 52 may damp a movement of the cylinder 52.1 relative to the piston and/or the piston rod 52.3.

The damper 52 may be at least partially received in a damper receptacle 51.1 of a damping housing 51. For example, the damper receptacle 51.1 may be a cylindrical bore. The damper 52 may be received in the damper receptacle 51.1 such that a stop surface 52.2, which may be an end surface of the cylinder 52.1 protrudes from the damper receptacle 51.1.

Further, the damping device 50 may comprise adjustment means 53. In the embodiments shown, the adjustment means 53 is designed as a bolt that is guided through a threaded bore aligned with the damper receptacle 51.1. The bolt may be in contact with the piston rod 52.3 of the damper 52. By adjusting the relative lengthwise position of the bolt to the damper receptacle 51.1, a position of the damper 52 may thus be adjusted.

As can be seen in FIG. 3, the one damping device 50 may be arranged such that, in the closed position, the first arm 11 may engage with a damper 52. In particular, the counter-stop surface 14.5 of the first arm 11 may engage with the stop surface 52.2 of the damping device 50. In the closed position, as shown in FIG. 3, the damping device 50 may be held in a compressed state by a force acting from the counter-stop surface 14.5 on the stop surface 52.2.

When the first arm 11 is moved from the closed position towards the open position, the damper 52 may leave the compressed state and move towards an extended state. For instance, the damping device 50 may comprise a spring that may bias the cylinder 52.1 and the piston and/or the piston rod 52.3 relative to one another into the extended state. When the first arm 11 is moved back toward the closed position from the open or a partially open position, the movement may then be damped by interaction with the damper 52.

Similarly, as seen in FIG. 4, another damping device 50 may be arranged such that, in the open position, the first arm 11 may also engage with a damper 52. In particular, the counter-stop surface 14.5 of the first arm 11 may engage with the stop surface 52.2 of the damping device 50. The damping device 50 may be held in a compressed state by a force acting from the counter-stop surface 14.5 on the stop surface 52.2. When the first arm 11 is moved toward the open position from the closed or a partially open position, the movement may be damped by interaction with the damper 52.

Further, FIGS. 3 and 4 show that stops 29.1, 29.2 may be provided to limit movement of the arms 11, 19. In particular, a first stop 29.1 may be provided to limit the movement of the first arm 11 in the closing direction. When the first arm 11 reaches the fully closed position, a closing counterstop surface 14 provided on the first arm 11 may come into contact with the first stop 29.1. Preferably, the first stop 29.1 is provided on a spacer 29. Similarly, a second stop 29.2 may be provided to limit the movement of the second arm 19 in the opening position. When the second arm 19 reaches the fully open position, an opening counterstop surface 22 of the second arm 19 may come into contact with the second stop 29.2. Preferably, the second stop 29.2 is provided on a spacer 29.

Opening and/or closing movement of the arms 11, 19 may be supported by an opening and/or closing device 40. The opening and/or closing device 40 may bias the first arm 11 toward the closed position as seen in FIG. 3. Further, the opening and/or closing device 40 may bias the first arm 11 toward the open position as seen in FIG. 4.

The opening and/or closing device 40 may comprise a spring 41 that may be held at a spring mount 44 at one end and that may be connected to the first arm 11 at the other end. For instance, as best seen in FIG. 5, the spring mount 44 may comprise a holding section 44.1 that may serve as an abutment for a second attachment section 41.2 of the spring 41. Preferably, the spring 41 is a tension spring.

The spring mount 44 may further comprise a fastening section 44.2 enabling securing the spring mount 44 to the cabinet 1, preferably to the rear wall of the cabinet 1. For instance, the fastening section 44.2 may comprise mounting bores 44.3 through which suitable fixing means such as screws or bolts may be guided to engage with the cabinet 1.

With a first attachment section 41.1 opposing the second attachment section 41.2, the spring 41 may be connected to the first arm 11. It is conceivable, however, that alternatively or additionally, the spring 41 is connected to the second arm 19 and/or that a plurality of springs 41 is provided to be connected to the first arm 11 and or the second arm 19.

In the embodiment shown in the drawings, the first attachment section 41.1 is held at a first connecting element 45.1 that is secured to a connector 45, which connector 45 is in turn connected to the first arm 11 by means of a second connecting element 45.2. As shown in FIGS. 3 and 4, the second connecting element 45.2 may be a bolt. The second connecting element 45.2 may be partially receivable in a corresponding receptacle of the first arm 11. For instance, the receptacle may be aligned with the connecting bore 14.4 of the first bearing segment 12 (cf. FIG. 6).

In any case, it is preferable that the spring 41 is coupled to the first arm 11 spaced away from the first cabinet mount pivot bearing 13, in particular from the first pivot axis 13.4. Preferably, the coupling of the spring 41 to the first arm 11 is spaced from the first cabinet mount pivot bearing 13 and/or the first pivot axis 13.4 in a direction toward the door mount pivot bearing 32.

To enable both a force in the opening and the closing direction of the first arm 11, it may be provided that, during movement between the open and the closed position, a reversal point of the spring force is crossed. With the spring 41 being connected to the first arm 11 spaced from the first pivot axis 13.4, a reversal point is naturally achieved because the connection point of the spring 41 and the first arm 11 is guided on a circular arc around the first pivot axis 13.4. It will be appreciated that in this way, during the first part of the pivoting from the closed to the open position, the spring is lengthened, and during the second part of the pivoting, the spring is shortened.

As discussed above, in the embodiment of the drawings, the spring 41 is coupled to the first arm 11 by means of the second connecting element 45.2. Hence, during opening and closing, the second connecting element 45.2 is moved on a circular arc.

In order to accommodate for the movement of the second connecting element 45.2, guide means 28 may be provided on the cover plate 27. For instance, the guide means 28 may be an arc-shaped slot in the cover plate 27. The guide means 28, in particular the arc-shaped slot, may comprise a first end region 28.1 and a second end region 28.2. Moving from the closed position of the first arm 11, the second connecting element 45.2 may be moved from the first end region 28.1 along the arc-shaped slot toward the second end region 28.2. In the open position, the second connecting element 45.2 may be located in the second end region 28.2. The guide means 28 may provide for additional mechanical stability of the opening and/or closing device 40 and/or to provide enhanced guidance of the opening and/or closing device 40, in particular enhanced guidance for the second connecting element 45.2.

As already visible in FIGS. 1, 2, 3 and 4, the arms 11, 19 of the closure device 10 may not be parallel to one another in the open and/or in the closed position. Based on FIGS. 12 and 13, a more detailed explanation of a preferred geometric and kinematic arrangement of the closure device 10 will be given in the following.

FIG. 12 shows a schematic top view of a cabinet 1 equipped with a closure device 10 according to the invention, where the closure device 10 is in the closed position. In FIG. 13, the cabinet 1 of FIG. 12 is shown with the closure device 10 in the open position.

As discussed previously, the first arm 11 and the second arm 19 may be pivotably connected to the cabinet mount 26 about a first pivot axis 13.4 and a second pivot axis 13.4, respectively. Further, the first arm 11 and the second arm 19 may be pivotably connected to the door mount 30 about a third pivot axis 32.5 and a fourth pivot axis 32.5′, respectively.

The arms 11, 19 may pivotable between the closed and the open position, corresponding to the closed (cf. FIG. 12a) and the open state (cf. FIG. 13) of the door 6, respectively.

In FIG. 12a, the closed position of the arms 11, 19 and the closed state of the door 6 are shown in solid lines, in FIG. 13 the open position and the open state are shown in solid lines. In FIG. 12a, an intermediate position of the arms 11, 19 and an intermediate state of the door 6 are shown in dashed lines, in FIG. 13 the closed position and the closed state are shown in dashed lines.

As can be seen in FIG. 12a, viewed from the first and second pivot axes 13.4, 13.4′ in the direction of the third and fourth pivot axes 32.5, 32.5′, a first straight line L1 intersecting the first and third pivot axes 13.4, 32.5 and a second straight line L2 intersecting the second and fourth pivot axes 13.4′, 32.5′ may converge at an acute first angle A.

An embodiment in which, viewed from the first and second pivot axes 13.4, 13.4′ in the direction of the third and fourth pivot axes 32.5, 32.5′, a first straight line L1 intersecting the first and third pivot axes 13.4, 32.5 and a second straight line L2 intersecting the second and fourth pivot axes 13.4′, 32.5′ converge at an acute first angle A, such as shown in FIGS. 12 and 13, will henceforth be called a converging arrangement of the arms.

When the arms 11, 19 are moved from the closed position, the pivot axes 32.5, 32.5′ may follow arcuate first and second paths P1, P2, respectively, centered around the respective pivot axes 32.5, 32.5′. Due to the above-described first angle A, in vicinity of the closed position, the second path P2 may have a larger directional component facing away from the cabinet 1 compared to the first path P1. This may lead to a certain degree of tilting of the door 6 in a counter-clockwise direction about an axis perpendicular to the drawing plane. The first angle A may thus allow a third path P3 to bypass an edge of the second door 7 without a collision between the door 6 and the second door 7, as can be seen more clearly in the detail shown in FIG. 12b. The third path P3 may be the motion path of an edge of the door 6.

The advantage of the described arrangement over known arrangements can be more clearly understood by comparison with the arrangements according to FIGS. 14 and 15, which are not in agreement with the converging arrangement of the arms. FIGS. 14 and 15 show parallel arrangements of arms 111, 119, more particularly parallel arrangements of first and second straight lines L100, L200 corresponding to the first and second straight lines L1, L2 described above.

Referring first to FIG. 14a, and to the detail shown in FIG. 14b, it is obvious that, with the parallel arrangement, the above-described advantages cannot be achieved. In particular, as seen in FIG. 14b, the first door 106 will collide with the second door 107 upon opening. This means that, compared to converging arrangement of the arms, a larger gap must be provided between the doors 106, 107 in order to prevent collision. However, a larger gap may be impractical and/or undesirable for aesthetic reasons.

However, even with a parallel arrangement, a smaller gap between the doors 106, 107 may be achieved. Such an arrangement is shown in FIG. 15a. This arrangement achieves a larger directional component facing away from the cabinet 101 compared the arrangement of FIG. 14a by moving the pivot axes 113.4, 113.4′ associated with the cabinet 101 closer to the front edge (lower edge in the drawing plane). As can be seen in the detail shown in FIG. 15b, the door 106 may now be opened without collision.

However, as evident from FIG. 15a, the arms 111, 119 need to be at a very small angle to a front plane of the door 106. This small angle leads to the disadvantage that tilting forces acting on the door 106 about an axis perpendicular to the drawing plane cannot be effectively absorbed by the arms 111, 119, as they comprise large components perpendicular to the longitudinal extension of the arms 111, 119 and thus result in bending of the arms 111, 119. In other words, a configuration as shown in FIG. 15 is vulnerable to tilting of the door 106. Tilting of the door 106 may be due to the placement of a handle on which a user acts relative to the position of the bearings of the arms 111, 119 on the door. During use, in particular during opening and/or closing, such a door 106 may feel unstable and wobbly to a user.

By comparison with the converging arrangement of the arms as shown in FIG. 12a, it is evident that the arms 11, 19 are much better positioned to absorb such forces. Nevertheless, a small gap between the door 6 and the second door 7 may achieved at the same time.

Referring back to FIG. 13, it can further be seen that, in the open position, viewed from the first and second pivot axes 13.4, 13.4′ in the direction of the third and fourth pivot axes 32.5, 32.5′, the first straight line L1 and the second straight line L2 may diverge at a second angle B.

Further, in the closed and/or in the open position, a third straight line L3 intersecting the first and second pivot axes 13.4, 13.4′ and a fourth straight line L4 intersecting the third and fourth pivot axes 32.5, 32.5′ may enclose a finite third angle C with respect to each other.

In particular, as shown in the drawings, the pivot axes (13.4, 13.4′, 32.5, 32.5′) may be arranged such that viewed along a resulting opening direction (D3) defined to point along the displacement of the third and/or fourth pivot axis (32.5, 32.5′) in the closed relative to the open position, the fourth pivot axis (32.5′) preferably follows the third pivot axis (32.5) and the second pivot axis (13.4′) preferably follows the first pivot axis (13.4). The resulting opening direction D3 as illustrated in FIG. 13 points from the location of the pivot axis 32.5 in the closed position to the location of the pivot axis 32.5 in the open position.

As can be further seen in FIG. 13, preferably in the orientation of the fourth straight line L4 in the open position is parallel to the orientation of the fourth straight line L4 in the closed position. In this case, the door 6 may, in the open state, be parallel to the second door 7, and/or be in an orientation parallel to that of the closed state.

In FIG. 12a, it is further illustrated that, in the closed state of the door 6 and/or the second door 7, a front face 6.1 of the door 6 and a front face 7.1 of the second door 7 may lie in one plane.

1-15. (canceled)

16: A closure device for movable attachment of at least one movable furniture part to a stationary structure to enable movement of the movable furniture part relative to the stationary structure between a closed state and an open state, the closure device comprising:
at least one stationary mount for mounting to the stationary structure;
at least one movable mount for mounting to the movable furniture part; and
at least one arm pivotably connected to the stationary mount about a pivot axis of a stationary mount pivot bearing and pivotably connected to the movable mount about a pivot axis of a movable mount pivot bearing;
wherein the at least one arm is pivotable between a closed position and an open position configured to correspond to the closed state and the open state, respectively, of the movable furniture part; and
wherein the at least one arm further includes a guide configured to transmit a load at least partially in a load transmission direction parallel to the pivot axis of the stationary mount pivot bearing and/or parallel to the pivot axis of the movable mount pivot bearing.

17: The closure device of claim 16, wherein:
the guide is spaced apart from the stationary mount pivot bearing in a direction transverse to the pivot axis of the stationary mount pivot bearing.

18: The closure device of claim 16, wherein:
the guide includes a roller rotatable about an axis transverse to the pivot axis of the stationary mount pivot bearing.

19: The closure device of claim 18, wherein:
the roller is at least partially received in a roller receptacle of the at least one arm; and
an outer circumferential surface of the roller partially protrudes from the roller receptacle in the load transmission direction.

20: The closure device of claim 18, wherein:
the roller is mounted to the at least one arm by an axle at least partially received in an axle receptacle of the at least one arm; and
the roller receptacle and the axle receptacle are in spatial connection with one another.

21: The closure device of claim 18, wherein:
the roller rolls on the stationary mount during pivoting of the at least one arm between the closed position and the open position.

22: The closure device of claim 16, wherein:
the at least one arm includes a bearing segment, the bearing segment including the stationary mount pivot bearing and the guide.

23: The closure device of claim 16, wherein:
the at least one arm includes at least two segments which can be secured to one another in multiple positions relative to one another in a longitudinal direction of the at least one arm.

24: The closure device of claim 16, further comprising:
at least one dampener configured to dampen a pivoting movement of the at least one arm when the at least one arm is approaching the closed position and/or the open position.

25: The closure device of claim 24, wherein:
the at least one dampener includes a stop surface; and
the at least one arm includes a counter-stop surface configured to engage the stop surface when the at least one arm approaches the closed position and/or the open position.

26: The closure device of claim 25, wherein:
the at least one arm includes a disk rotatably mounted on the at least one arm, and the counter-stop surface is an outer circumferential surface of the disk.

27: The closure device of claim 26, wherein:
the disk is rotatable about an axis parallel to the pivot axis of the stationary mount pivot bearing.

28: The closure device of claim 26, wherein:
the disk is partially received in a disk receptacle of the at least one arm such that the counter-stop surface partially protrudes from the disk receptacle.

29: The closure device of claim 16, wherein:
the at least one arm includes a first arm and a second arm pivotably connected to the stationary mount about a first pivot axis of a first stationary mount pivot bearing and a second pivot axis of a second stationary mount pivot bearing, respectively;
the first arm and the second arm are further pivotably connected to the movable mount about a third pivot axis of a first movable mount pivot bearing and a fourth pivot axis of a second movable mount pivot bearing, respectively; and
the first arm and the second arm are pivotable between closed positions and open positions configured to correspond to the closed state and the open state, respectively, of the movable furniture part.

30: The closure device of claim 29, wherein:
in the closed positions of the first arm and the second arm, when viewed from the first and second pivot axes in a direction toward the third and fourth pivot axes, a first straight line intersecting the first and third pivot axes and a second straight line intersecting the second and fourth pivot axes converge at an acute first angle.

31: A closure device for movable attachment of at least one movable furniture part to a stationary structure to enable movement of the movable furniture part relative to the stationary structure between a closed state and an open state, the closure device comprising:
at least one stationary mount for mounting to the stationary structure;
at least one movable mount for mounting to the movable furniture part; and
at least one arm pivotably connected to the stationary mount about a pivot axis of a stationary mount pivot bearing and pivotably connected to the movable mount about a pivot axis of a movable mount pivot bearing, wherein the at least one arm is pivotable between a closed position and an open position configured to correspond to the closed state and the open state, respectively, of the movable furniture part; and
at least one opening and/or closing device configured to bias the at least one arm toward the closed position during a first part of a pivoting from the closed position to the open position and/or to bias the at least one arm toward the open position during a second part of the pivoting from the closed position to the open position.

32: The closure device of claim 31, wherein:
the at least one opening and/or closing device includes:
a spring mount configured to be fixed relative to the stationary mount; and
a spring including a first attachment section and a second attachment section, the first attachment section being connected directly or indirectly to the at least one arm, and the second attachment section being connected directly or indirectly to the spring mount.

33: The closure device of claim 32, wherein:
the spring mount and the stationary mount pivot bearing are arranged such that between the first part of the pivoting from the closed position to the open position and the second part of the pivoting from the closed position to the open position a reversal point of a spring force applied by the spring to the at least one arm is crossed.

34: The closure device of claim 33, wherein:
the spring is a tension spring.

35: The closure device of claim 34, wherein:
the spring is lengthened during first part of the pivoting from the closed position to the open position; and
the spring is shortened during second part of the pivoting from the closed position to the open position.
